(19) United States
(12) Patent Application Publication
(10) Pub. No.: US 2024/0380241 A1
(43) Pub. Date: Nov. 14, 2024

(54) COMPUTER-IMPLEMENTED METHOD, ARRANGEMENT AND COMPUTER PROGRAM PRODUCT

(71) Applicant: Siemens Aktiengesellschaft, München (DE)

(72) Inventors: Domenico Tomaselli, München (DE); Paul Stursberg, München (DE); Michael Metzger, Markt Schwaben (DE); Christian Heuer, Seevetal (DE)

(21) Appl. No.: 18/661,944

(22) Filed: May 13, 2024

(30) Foreign Application Priority Data
May 12, 2023 (EP) 23173125.8

(51) Int. Cl. H02J 13/00

(52) U.S. Cl. CPC H02J 13/00028; H02J 13/00016

(57) ABSTRACT

A computer-implemented method for analyzing network information in an electrical energy supply grid includes the following steps: receiving serialized network information in a first application-specific data format by way of a communication device, wherein the serialized network information contains information about system components, deserializing the serialized network information by way of a deserialization device, and assigning component types based on the information about system components by way of a first assignment device, and assigning component properties based on the information about system components by way of a second assignment device, and providing a network topology that, as a graph, contains types and properties of the system components, in a second application-specific data format by way of a topology output device. There is also described a corresponding arrangement and a computer program product.

### CROSS-REFERENCE TO RELATED APPLICATION

This application claims the priority, under 35 U.S.C. § 119, of European Patent Application EP 23173125.8, filed May 12, 2023; the prior application is herewith incorporated by reference in its entirety.

### FIELD AND BACKGROUND OF THE INVENTION

The invention relates to a computer-implemented method for analyzing network information in relation to an electrical low-voltage grid and/or an electrical medium-voltage grid, to an arrangement for analyzing network information in relation to an electrical energy supply grid, and to a corresponding computer program product.

Software for what is known as a “Supervisory Control and Data Acquisition (SCADA)” system, that is to say a control center, is known from the product brochure “Intelligent control center technology—Spectrum Power”, Siemens AG 2017, Article No. EMDG-B90019-00-7600. SCADA systems have long been known for monitoring and controlling energy grids (Wikipedia permanent link: https://en.wikipedia.org/w/index.php?title=SCADA&oldid=858433181). They involve measured values from sensors, for example from voltage measuring units and current measuring units in the energy grid, being aggregated and transmitted to the control center. In order to control circuit breakers and isolating switches in the energy grid and to actuate energy generators such as power stations, control commands are sent to the energy grid. These control commands are received and processed by “remote terminal units” (RTUs), “programmable logic controllers” (PLCs) and “intelligent electronic devices” (IEDs) in order to actuate the circuit breakers and the isolating switches, etc. To date, there has often been provision in the control center for a local computing center on which the control center software, such as for example “Spectrum Power,” runs. Engineers who are able to monitor the displays of the SCADA relating to the present operating state of the energy grid and, in the event of a fault, to take countermeasures, such as, for example, shutting down a grid section, are provided in the control center around the clock. The control center software is generally operated in a central computer arrangement, which may be in the form of a computing center with processors, data memories and screens, for example. The term “central” indicates here that all measurement data from the energy grid and all control commands for the energy grid are processed centrally.

The computer arrangement, or the control center software, may also be produced partly or completely as a cloud application, that is to say a server arrangement with locally distributed resources for data processing and data storage that are connected by way of a data network, such as for example the Internet.

An accompanying phenomenon of the ever wider use of distributed power generation, that is to say for example by photovoltaic installations or wind power installations, is that the ever more numerous local power generators feeding into the low-voltage and medium-voltage grid make predicting a system state of the energy grid more difficult. Dependency on weather influences also increases because, for example, solar cells are heavily influenced by cloud coverage, and wind power installations are heavily influenced by wind strength. These problems also have repercussions for the next-highest voltage level of an energy transmission grid at the high-voltage level, which is therefore more difficult to control and to predict.

Traditional methods for state estimation from the field of transmission grids are difficult to employ in distribution grids owing to the lack of measured information at on average 80% of the grid nodes. Therefore, use is often made of conventional methods with what are known as pseudo-measurement values that are used to model the load information. However, these models are very inaccurate and usually require further methods such as for example load scaling in order to initialize the load information with the measured values.

The uncertainty regarding the measurement values exacerbates the problem of a missing or insufficiently known grid model. Distribution grid operators are able to plan and roll out additional measurement infrastructures only if correct and up-to-date information in relation to the grid model is also available.

System data from grid operators, such as for example data from a geographical information system (GIS data) describing for example the geographical location of resources and lines, are usually not stored in standardized form. This prevents the data exchange of system information between different grid operators and standardized processing in software products. GIS systems for energy supply grids are known for example from the publications “GIS Based Electrical System Planning and Network Analysis” by Mathankumar and Loganathan, World Engineering & Applied Sciences Journal 6 (4), pages 215-255, 2015 and “GIS for Electric Distribution” from ESRI.COM.

The transformation of system data into a standardized exchange format such as, for example, what is known as a “common information model” (CIM) format is currently not automated and requires manual processing that is complicated even for experts. CIM is at present more common in grid control centers at the high-voltage level, but not in software solutions at the low-voltage and medium-voltage level. For example, CIM (or a comparable format) may be used to exchange data from a SCADA system, a meter data management (MDM) system or a geographical information system and process the grid model for example for load flow or state estimation applications. On the one hand, the reason for the manual complexity is that the system data that are stored (for example in a GIS system) are usually only a serialization in which the topological system information is lost. On the other hand, system data are not stored in a standardized manner and therefore cannot easily be evaluated by software solutions.

To date, for example, what are known as “Extract-Transform-Load” software products have been used by human experts to enable a data exchange. However, this requires a large amount of manual work to control and monitor the data transformations. For example, a single project to parameterize control center software at the high-voltage level for an energy grid may require several days' work for an expert. Due to the much greater complexity of low-voltage grids, an amount of work of up to 2 orders of magnitude higher would be expected for the expert, which is generally not feasible due to staff shortages and the resulting costs. For example, the websites “GISGeography—Data Engineering in GIS: Let the ETL Journey Begin” (https://gisgeography.com/data-engineering-gis/) and “Spatial ETL Tools” (“https://desktop.arcgis.com/de/arcmap/latest/extensions/data-interoperability/spatial-etl-tools.htm”) explain known approaches from the prior art.

### SUMMARY OF THE INVENTION

Against the background of known methods for analyzing network information, the invention addresses the problem of specifying a method by way of which it is possible, comparatively easily, quickly and reliably, to use network information to recognize a grid topology.

With the above and other objects in view there is provided, in accordance with the invention, a computer-implemented method for analyzing network information in an electrical energy supply grid, the method comprising the following steps:
receiving, with a communication device, serialized network information in a first application-specific data format, the serialized network information containing information about system components;
deserializing the serialized network information by a deserialization device;
assigning, with a first assignment device, component types based on the information about system components;
assigning, with a second assignment device, component properties based on the information about system components; and
providing, with a topology output device, a network topology that, in form of a graph, contains types and properties of the system components in a second application-specific data format.

The electrical energy supply grid, by way of example, is a low-voltage grid and/or a medium-voltage grid.

By way of example, a medium-voltage grid has a rated voltage of 1 kV to 52 kV. By way of example, a low-voltage grid has a rated voltage of no more than 1 kV.

Network information is for example data about lines and installed resources that are present in the respective electrical energy grid, such as transformers and switching devices, their interconnection (topology) and parameterization (with regard to data communication or electrical limit values for triggering switching operations). This network information may be present in different data formats at different grid operators due to different software, and is generally only able to be exported in serialized form in the form of data tables. By way of example, a file containing text, table entries, etc. may be present in CSV format. The invention makes it possible to receive the serialized network information from a first network operator in an application-specific data format that differs from the application-specific data format of other network operators. The invention thus provides a quasi-universal method for reading network information and combining it to form a consistent topology. This does away with the need to program a data conversion method for any conceivable combination of first application-specific data formats as input and the second application-specific data format as output.

By way of example, a communication device is designed for data communication according to the TCP/IP protocol, another common Internet communication protocol or the communication standard IEC 61850.

A device within the meaning of the invention has for example processors, processor cores, GPUs, data memories and optionally an output device such as a screen. It is also possible for the device to be produced partly or completely as software. Provision may also be made to use a cloud application, that is to say a software component for execution on a server arrangement with locally distributed resources for data processing and data storage that are connected by way of a data network, such as for example the Internet.

System components are for example the components that make up the distribution grid, such as lines and resources.

Deserializing the serialized network information means for example rebuilding a complete topological replica of the electrical energy grid from the serialized information, which contains for example tables containing data regarding transformers and switching devices.

A component type has for example an exact name of a system component such as a line, a transformer, a switch, etc.

The component type may be stored with manufacturer information (exact model name, identifier, parameters, performance, etc.). These are component properties within the meaning of the invention.

The network topology comprises for example a mathematical graph that is provided in the second application-specific data format, that is to say a dataset able to be visualized as a circuit diagram. It contains types and properties of the system components.

An overview of other definitions of terms that are used is given in the following table:

| Term: | Description: |
|---|---|
| System | A graph consisting of georeferenced nodes and edges. The |
| topology | assignment of system components as nodes and edges is |
| | initially not present. |
| System | The components that make up the distribution grid (general |
| components | definition, exact type of grid component not meant). |
| Component | Exact name of a system component (for example line, |
| type | transformer, switch, etc.). |
| Third-party | Column in the data table containing the connectivity |
| keys | information with further, different data tables. |
| Taxonomy | List of terms (for example system components, properties |
| | of the system components). |
| Ontology | Taxonomy (in the logic sense) containing additional |
| | relationships and derivation rules regarding the terms (for |
| | example comparable to what is known as an “Entity |
| | Relationship Diagram”, a common modeling approach). |
| Users | Grid operator experts responsible for manual interventions |
| | and user feedback when assigning the system component |
| | and column entries. |
| Provider | Experts from the software provider or manufacturer, |
| experts | responsible for defining the internal ontology and target |
| | format-dependent taxonomy. May also be responsible for |
| | validating and generalizing additional user-defined rules |
| | and roll-outs of updates. |

The invention provides an approach that deserializes grid operator system data in the form of a system topology and keeps the transformation into a target format as automated as possible and independent of external data models. This limits or eliminates manual work involved in transforming the system data into an exchange format, and at the same time enables the data exchange of system information between different grid operators and standardized processing in software products.

Transforming grid operator system data into a target format at present has to be carried out by a human expert, which is time-consuming and error-prone.

The invention, by virtue of the automated or partially automated deserialization of the input data and a transformation into the target format for grid control center software, provides a solution to a problem that is occurring increasingly frequently. At present, there is no application-ready, automated solution on the market that allows grid operators to transfer the topology information present in the software solutions at the lower voltage levels to the responsible grid control center. Manual evaluation of the highly varying editions of the wide variety of software solutions would require weeks to months of work for experienced specialists, which is not feasible in terms of cost and time.

The advantages of the proposed approach include the following aspects:
a scalable approach to different grid operator input data is set up and converted into a uniform target format for data exchange.
provision may be made for an expert to review the automatically generated results and, if necessary, to adapt intermediate results. This is a highly flexible approach. This user feedback may be used to refine the approach. This refinement may be shared with other users in the form of a software update. The more the system is used, the more precise it becomes.
When using machine learning methods, the accuracy and degree of automation is improved with increased use, even in the case of a single grid operator/a single control center (the method according to the invention makes fewer errors).
It is an end-to-end approach to transforming input data into the target format.
The approach makes it possible to perform automated deserialization of grid operator system data independently of external data models (for example input and output data models).

The invention may be used to configure an energy grid once. However, in one development, the process may also be repeated regularly in order to automatically configure new resources (photovoltaic systems on rooftops, electric car charging columns, etc.) when these are added to the low-voltage level or the medium-voltage level. Without the solution according to the invention, the manual work required for such a configuration would not be feasible for a large city with more than 10,000 local grid transformer stations.

The invention also weeds out large amounts of data that are not required from the network information and discards them. These may be for example parameters for protective equipment, names of maintenance engineers, etc.

The publication “Building Large-Scale U.S. Synthetic Electric Distribution Systems Models” by Mateo et al., IEEE Transactions on Smart Grid, Vol 11, No. 6, November 2020, does disclose a method for creating a system topology. In contrast to the invention, however, no network information from a real grid is imported here, but rather this is approximated from publicly accessible sources such as road maps. The publication also requires system components and system properties to be known a priori. The invention goes beyond this approach.

In one preferred embodiment of the computer-implemented method according to the invention, the network topology is used to control the electrical low-voltage grid and/or an electrical medium-voltage grid by way of a grid control device.

In a further preferred embodiment of the computer-implemented method according to the invention, a rule-based method is used for the deserialization, in which identification columns in data tables are recognized based on the serialized network information, and the system components are recognized as being connected to one another based on identifiers in the identification columns. Identifiers may for example be recognized by the fact that there is a one-to-one character combination for all entries in a table column, that is to say there are no duplicate entries. Voltages, on the other hand, may for example be recognized by the fact that the relevant column contains discrete values in a range of values matched to the rated voltage of the energy grid. The method according to the invention thus gets around the problem that the header or the heading of a table column is often not clearly designated. By way of example, an operating company may enter an abbreviation or a name in a foreign language, meaning that, in the described approach, a readout based on an unknown serialized data format with reference to the column headings does not work.

In a further preferred embodiment of the computer-implemented method according to the invention, a rule-based method is used to recognize the component types. The rules for the method are prescribed in this case by human experts.

In a further preferred embodiment of the computer-implemented method according to the invention, machine learning is used to recognize the component types. By way of example, it is possible to use an artificial neural network that uses a publicly accessible software library, such as for example TensorFlow, as a base. In particular, what is known as a “graph neural network” may advantageously be used. In this case, no recurrent neural networks or convolutional neural networks (CNNs), as they are known, are generally used. For the “supervised training”, provision may be made for example for a training dataset that uses GIS datasets of a control center system. As an alternative or in addition, a training dataset may be derived from synthetic data, for example based on “OpenStreetMap.”

In a further preferred embodiment of the computer-implemented method according to the invention, at least one of the following system components is used for system components; transformer, line, switching device, protective equipment, grid regulator.

In a further preferred embodiment of the computer-implemented method according to the invention, the component properties are assigned to the recognized component types based on a predefined taxonomy and a predefined set of rules.

Against the background of known arrangements for analyzing network information, the invention also addresses the problem of specifying an arrangement by way of which it is possible, comparatively easily, quickly and reliably, to use network information to recognize a grid topology.

With the above and other objects in view there is also provided, in accordance with the invention, an arrangement for analyzing network information in an electrical energy supply grid, the arrangement comprising:
a communication device for receiving serialized network information in a first application-specific data format, the serialized network information containing information about system components;
a deserialization device for deserializing the serialized network information;
a first assignment device for assigning component types based on the information about system components;
a second assignment device for assigning component properties based on the information about the system components; and
a topology output device for providing a network topology, in form of a graph containing types and properties of the system components, in a second application-specific data format.

In accordance with a preferred feature of the invention, there is provided a grid control device that uses the network topology to control the electrical energy supply grid.

Preferred embodiments of the novel arrangement provide for the same or analogous advantages as the above-summarized method.

Against the background of known computer program products for analyzing network information, the invention also addresses the problem of specifying a computer program product by way of which it is possible, comparatively easily, quickly and reliably, to use network information to recognize a grid topology.

The invention solves this problem by way of a computer program product as claimed. The same advantages as explained at the outset for the method according to the invention also result analogously.

One preferred exemplary embodiment of the invention is presented below.

A technical overview of the approach is described below. The system architecture is presented first of all, followed by the proposed methodology for solving the problem.

With regard to the software architecture, the approach corresponds to what is known as an “on-premises” client-server architecture. The work of the system is divided into two subsystems:
a) Client: for example, a local computer of the user present at the distribution grid operators and that asks for its system data to be transformed into the standardized exchange format; this may possibly be identical to the server.
b) Server: for example a central computer present at the grid operators and on which the system data are stored and the approach is executed. The output from the system in the form of standardized data models is likewise stored here.

The data exchange between the client and the server takes place for example in XML format using a communication protocol to which both subsystems adhere (for example FTP).

An extension of the system to an off-premises client-server architecture is possible in another embodiment. In that case, selected functions or modules of the system are executed in the cloud (or provider server). Such an architecture would facilitate and promote cooperation with provider experts and other grid operators to further develop the approach.

Specifically, the software architecture is structured as follows:

The first stage (a so-called “front-end”) is the “user interface” (UI) stage and serves as an interface between client and server. The UI stage runs on the client side and allows the user to define the workflow and to visualize and evaluate the results arising therefrom, for example via a GIS application.

The second stage (a so-called “back-end”) runs on the server side and consists of the data stage and a series of modules that use the functionality of the proposed methodology. The file system or database containing the system data is maintained by the grid operator. When the software architecture is off-premises, selected modules run in the cloud. The back-end provides appropriate APIs for the correct interaction between client and server.

The solution according to the invention to the problem outlined at the outset is structured as follows:
I. Deserialization of the system data to form a system topology using a rule-based method. The set of rules is defined by provider experts and may possibly be extended/refined by the user.
II. Partially automated assignment of the system components based on a fixed, internal ontology with regard to the system components. This ontology is independent of external data models. The assignment takes place using a rule-based method or an Al method, possibly with the cooperation and/or supervision of the user.
III. Partially automated assignment of the properties of the column entries based on a target format-dependent taxonomy. The taxonomy is initially defined by provider experts. It may then be extended by using the tool. The assignment takes place using a rule-based method in which a manual intervention may be carried out for supplementing/correction purposes.

### Re I: Deserialization

The rule-based approach to deserializing the input data to form a system topology is set forth below. In this case, the input data are deserialized automatically and independently of external data models (that is to say input or output data models) to form a system topology. Such deserialization reconstructs the topological system information and enables a graphical overview with regard to the connectivity between the system components. Such an output firstly reduces the work for a user in the case of manual interventions, and secondly enables the use of the next step, in which the method accesses the connectivity information. The method works with the following steps:

To recover the connectivity information between two system components, the entries (or table rows) of a data table contained in the input data or network information are first searched according to what are known as the ID columns. These columns contain unique identifiers of each table row.

a. The connectivity information of the first system component is then validated on the other system components. This is carried out by checking whether what is known as the third-party key of the first system component matches the third-party key of the other system component. If the validation fails, the approach attempts to identify another ID column in the data tables.

b. If the approach is not able to find any ID columns with the matching third-party key, then the connectivity information is generated in a rule-based manner. In such a case, connectivity between two network components is assumed when the spatially close endpoints are located within a predefined perimeter (are closely adjacent).

c. As output, the method produces a system topology in the form of a graph having georeferenced nodes and edges. In addition to the geographical coordinates, nodes and edges are also assigned the respective properties from the data tables.

d. This method is independent of external data models and takes place in an automated manner. However, it is possible for the user to check the output and, if necessary, to make manual adaptations to the structure of the graph. For each adaptation, the user is asked to define a motivation in the form of a rule. Such local rules are then validated by the provider experts and if necessary generalized and then integrated into the rule-based method. The adapted set of rules is then made available to the user as an update.

### Re II.: Assignment of System Components

The approaches—a rule-based method and an active learning-based method, that is to say a machine learning method—for the assignment of the system components are set forth below.

It is advantageous here, in a first step, not to perform both methods in a fully automated manner, but rather to adapt them based on a basic functionality with reference to user feedback in order to refine the accuracy. Once the component types have been assigned, the user has the possibility of extending the system topology with additional system components that are not defined in the fixed ontology and are target format-specific.

In the rule-based method, the set of rules is initialized by provider experts on the basis of a predefined ontology of the system components. Such an ontology is independent of external data models and comprises the usual system components of a distribution grid along with their relationships and derivation rules. The rules for the assignment are governed by the topological properties of the nodes and edges (for example degree of the node, that is to say a node with a high degree has a large number of neighbors, etc.) as well as the data entries (for example binary entries, which indicates the switch positions open/closed).

Using the initial set of rules, the method produces a first suggestion that is then shown to the user in connection with the system topology for evaluation by said user. In the evaluation, particular attention is paid to all assigned system components whose confidence value, as it is known, lies below a user-defined threshold value. In other words, those results that give rise to the greatest uncertainty with regard to correct assignment are offered to the expert for manual review.

By way of example, no electrical islands should show up in the energy grid during evaluation. If this is the case, then the assignment of the corresponding system components receives a very low confidence value. By way of example, a case may occur in which the method recognizes a load with 99% certainty and a transformer with 70% certainty. In this case, the load would have a higher confidence value—a load would be recognized.

By way of example, a node whose connected edges have different voltages in the range of different voltage levels is recognized as a transformer. This rule-based procedure characterizes a conventional expert system. However, no expert systems have been commercially available to date for this topology recognition application.

Such nodes or edges are marked automatically so that the user is able to be made particularly aware. In principle, the proposed assignment of all nodes and edges may be adapted by the user, but only the marked nodes and edges are recommended. When the user adapts the proposed assignment of a marked node or a marked edge, they are asked to formulate an additional rule that motivates their decision.

The additional rules defined in this way are validated by provider experts and if necessary generalized and supplemented to the initial set of rules in order to improve the method. The additions are then made available to the user in the form of an update. Such a procedure results in system components that were lower than the mentioned confidence value in the previous iteration being higher than it in future iterations.

The active learning-based method is described below:

Based on the predefined system component ontology, a dataset is initialized manually by provider experts (that is to say supervised learning takes place). Such a dataset is used for the initial training of a neural network and comprises system topologies whose nodes and edges have already manually been assigned a system component.

The trained neural network then evaluates a system topology without assigning the system components to the nodes and edges and produces a suggestion for assigning the system components. In the next step, what is known as a “pool-based sampling” method, for example, is used to mark all nodes and edges whose suggestion is least accurate. Such marked samples represent the samples for which the neural network has the lowest understanding. The suggestion containing the marked samples is shown to the user in conjunction with the system topology, and the system component of all marked samples may be confirmed by the user (if the component type is correct) or adapted accordingly. In principle, all system components may be adapted by the user, but only the marked samples are mandatory. Following the user feedback, the adapted suggestion is integrated into the original training dataset and the neural network is retrained based on the extended dataset. This increases the accuracy of the suggestion in the next iteration due to the additional information and retraining. A more accurate suggestion also results in a smaller number of marked samples in the next iteration, and at the same time in reduced user feedback. The refined neural network may then be made available to other users for future applications via an update.

### Re III.: Assignment of Properties

The approach to assigning the properties of the system components is set forth below. For this purpose, provider experts define a simplified taxonomy of the properties and provide a set of rules for the assignment. Provider experts do not know a priori all mandatory properties that are necessary for the transformation into the target format. For this reason, the taxonomy originally contains only a minimal requirement in terms of properties. If the target format is based on an ontology that is derived from the same basic ontology of the internal ontology for assigning the system components, then the taxonomy may be extracted directly from such an ontology. The initial set of rules may integrate relationships and derivation rules from the internal ontology. The assignment of the properties of the system components is structured as follows:

Each node and each edge from the system topology is assigned the respective data from the data table. Based on the initial dataset, the rule-based approach assigns all properties contained in the taxonomy to the respective “records” or system components. If no property and rule represents a record type, no property is assigned either.

In the next step, the user evaluates which records have not received a property and adds a new property in the taxonomy, on the one hand, and defines a new matching rule for its assignment, on the other hand. Such additional properties and rules are validated by provider experts and if necessary generalized and then integrated into the taxonomy and into the set of rules. The expectation is that such a procedure will result in properties that were not assigned in the previous iteration being able to be assigned in the next iteration. Such a method reduces the manual work for the user and gradually increases the automatability of the method.

After all column entries required by the target format have been assigned manually or automatically, the method transforms the output into the defined target format.

Additional features which are considered as characteristic for the invention are set forth in the appended claims.

Although the invention is illustrated and described herein as being embodied in a computer-implemented method, arrangement and computer program product, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a first exemplary embodiment of the invention;

FIG. 2 shows an overview flowchart of a method according to the invention; and

FIG. 3 shows one example of an assignment of system components and system properties.

### DETAILED DESCRIPTION OF THE INVENTION

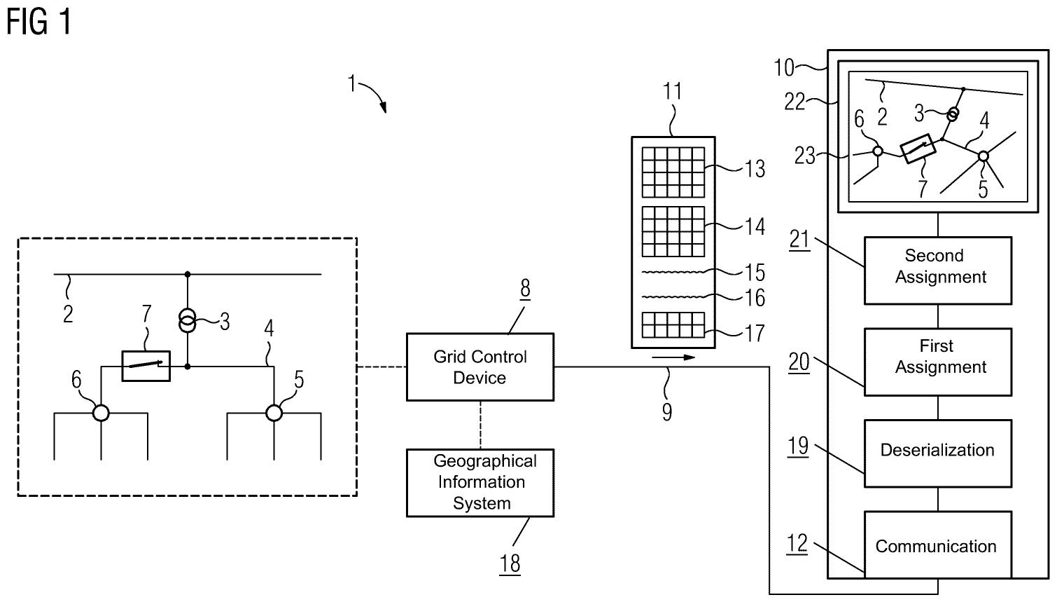

Referring now to the figures of the drawing in detail and first, in particular, to FIG. 1 thereof, there is shown a first exemplary embodiment of the invention. The computer-implemented method 1 pertains to an electrical low-voltage and medium-voltage grid 2, 3, 4, 5, 6, 7 controlled by a grid operator. A transformer 3 is connected to a medium-voltage line 2 and supplies the low-voltage level 4 with electrical energy. The low-voltage level also contains a switching device 7 and distribution nodes 5, 6 for supplying power to individual streets or households. This electrical energy supply grid is partly monitored by way of sensors. The measured values from the sensors are processed in a grid control device 8 of the grid operator. Furthermore, a geographical information system 18 provides a topology of the electrical energy supply grid 2, 3, 4, 5, 6, 7 for the grid control device 8, that is to say the geographical position and interconnection of the resources is known.

The grid control device 8 is able to export the existing network information, that is to say the topology containing information about the interconnection of the lines and the resources and sensor data, etc., but not in a form that makes it possible to reconstruct the geographical information about the position and type of the resources and their properties directly in the form of a graph.

Instead, the grid control device 8 is designed to output the available network information in serialized form as a file 11, for example in CSV format. The file essentially contains text and number entries in tables 13, 14, 17 and lines containing text 15, 16. The file 11 is transmitted from the grid control device 8 of the local grid operator via a data communication connection 9 to a communication device 12 of an arrangement 10 for analysis of network information.

The arrangement 10 is for example part of a grid control center of a superordinate energy transmission system at a high-voltage level, to which the operating companies of the local medium-voltage and low-voltage grids with their grid control devices 8 are subordinate. The arrangement 10 has a deserialization device 19 that is designed to deserialize the serialized network information from the file 11. As output of the deserialization device, the network information from the file 11 is again in the form of a graph having nodes and edges, wherein the resources or system components and their properties are not yet assigned to the nodes. For this purpose, provision is made for a first assignment device 20 for assigning the component types. In a next step, a second assignment device 21 is designed also to assign the component properties of the system components. All this information is provided as a graph in a topology output device 22 in the form of a network topology, wherein the graph contains the properties of the system components as well as their geographical information.

The invention has made it possible to provide the file 11 in a first application-specific data format in serialized form in an output file 23 in a second application-specific format, without the exact data type and the data structure for the file 11 exported by the grid control device 8 having to be predefined beforehand.

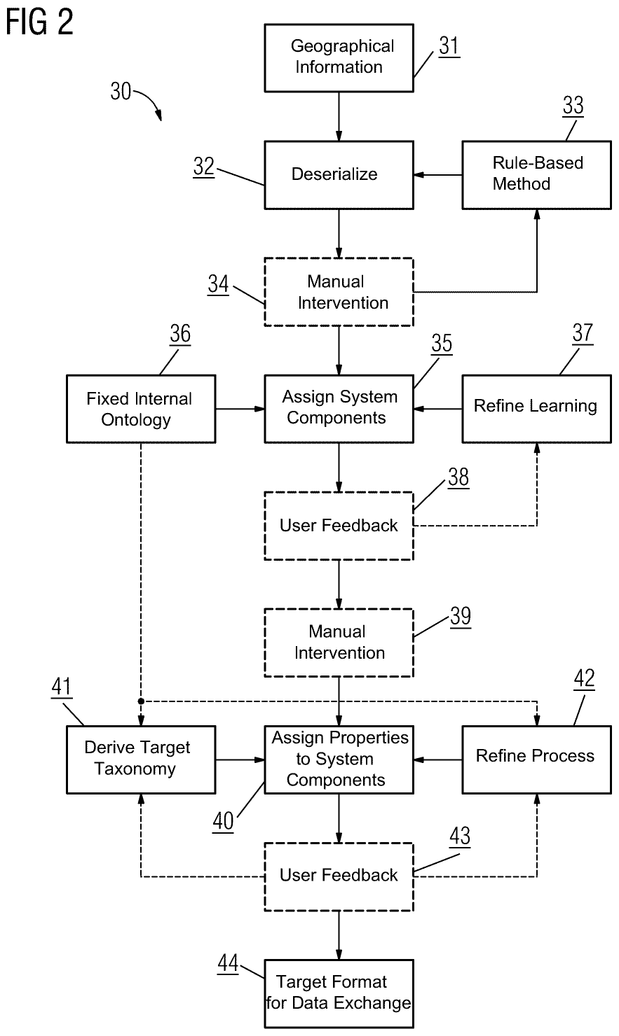

FIG. 2 shows one example 30 of an assignment of system components and system properties. Mandatory method steps are in this case indicated with solid boxes, while optional steps (generally manual checks or corrections) are indicated in dashed boxes. The input data of a grid operator, such as for example geographical information data, are provided in a first step 31 and deserialized in a second step 32 to form a system topology. Step 34 provides an optional manual intervention to adapt the system topology, which may be used to refine the methodology if necessary. The result of step 34 is fed into the rule-based method 33 as part of a feedback loop in order to refine the deserialization methods. The enhanced method 33 for deserializing the system topology may then in turn be used in step 32 to achieve an even better result.

The deserialized system topology is used in step 35 to assign system components. In an optional step 38, user feedback regarding the correctness of the assignment of the system components may be given, which, in turn, is used in step 37 to refine a rule-based or active learning method. Provision is thus also made here for a feedback loop. The refined rule-based or active learning method 37 is then executed again in step 35 in order to enable an improved assignment of the system components. It is also possible, in a further optional step 39, to provide a manual intervention for additional system components that have not been correctly recognized.

In the next step 40, the properties are assigned to the system components. In this case too, user feedback may be given in step 43, which is processed via a feedback loop in order to refine the method in step 42. The refined rule-based method is used as part of a feedback loop in turn in step 40 to assign the properties of the system components. Optional user feedback from step 43 may also be used to provide a feedback loop for extending the taxonomy. In this case, in step 41, a target format-dependent taxonomy is derived from the internal ontology or defined explicitly. By way of example, this target format-dependent taxonomy from step 41 may be provided as part of a feedback loop for refined assignment of the properties of the system components in step 40. The target format-dependent taxonomy from step 41 may furthermore also be used to refine the rule-based method from step 42.

Provision may also be made, in a step 36, to provide a fixed internal ontology of the system components 36, and to make this available to step 35 for the assignment of the system components.

If the target format is based on an ontology that is derived from the same basic ontology of the internal ontology, then the fixed internal ontology from step 36 may also be made available to step 41 in order to specify a target format-dependent taxonomy.

In the final step 44, the target format for the data exchange is provided in the second application-specific data format by then making available a graph with stored system components, their topology and geographical position and properties. By way of example, what is known as a CIM model may be used.

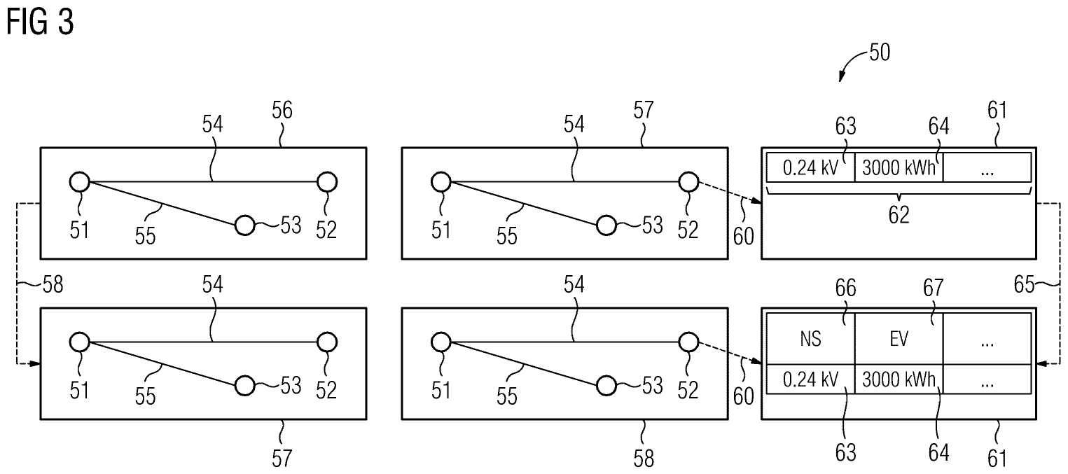

FIG. 3 shows one example 50 of an assignment of system components and system properties. In a first step, graph information 56 is already available, that is to say deserialized network information is indicated as a system graph with nodes and lines. However, the type of nodes and edges is unknown. In the example, the system graph 56 shows nodes 51, 52, 53 that are connected to edges 54, 55.

By way of example, a rule-based method may be applied to this system graph 56. A first rule may in this case be implemented such that a transformer is recognized if there is more than one line coming from one node. Accordingly, the node 51 is recognized as a transformer. A second rule may be applied that states that a node is a load if there is no edge coming from the node. Accordingly, the two nodes 52, 53 are recognized as loads. As a result, applying the rules in a step 58 generates a system graph 57 in which system components are assigned to the nodes.

In a next step, the system components and their properties are assigned for the system graph 57. By way of example, as a starting situation, the system graph 57 with an assignment of the system components is available, wherein a data table containing entries, or records, for the properties of the system components is available. By way of example, the data table 61, in one row, contains the entry 0.24 kilovolts in the cell 63 and 3000 kilowatt hours in the cell 64. There may be different entries 62 for a load here. This data table 61 is then evaluated, for example, using a rule-based method. A first rule may be: if kV is written in a column, then this is the nominal voltage. Another rule may be that if kilowatt hours (kWh) appears in a column, this is an energy consumption value. As a result, a system graph 58 is generated in which the load 52 (indicated here by an arrow 60) is assigned entries in the data table 61. The method has been used here to recognize that the cell 63 involves a nominal voltage, indicated here in cell 66 with the entry NS. It has also been recognized that the cell 64 involves an energy consumption, indicated here by the entry EV in the cell 67. The result of the method is thus the system graph 58 in which all of the nodes are assigned the type of system components and the system properties in accordance with further data tables.

1. A computer-implemented method for analyzing network information in an electrical energy supply grid, the method comprising the following steps:
receiving, by a communication device, serialized network information in a first application-specific data format, the serialized network information containing information about system components;
deserializing the serialized network information by a deserialization device;
assigning, by a first assignment device, component types based on the information about system components;
assigning, by a second assignment device, component properties based on the information about system components; and
providing, by a topology output device, a network topology that, in form of a graph, contains types and properties of the system components in a second application-specific data format.

2. The computer-implemented method according to claim 1, which comprises using the network topology to control the electrical energy supply grid by way of a grid control device.

3. The computer-implemented method according to claim 1, wherein the deserializing step comprises using a rule-based method for a deserialization, in which identification columns in data tables are recognized based on the serialized network information, and the system components are recognized as being connected to one another based on identifiers in the identification columns.

4. The computer-implemented method according to claim 1, which comprises using a rule-based method to recognize the component types.

5. The computer-implemented method according to claim 1, which comprises using machine learning to recognize the component types.

6. The computer-implemented method according to claim 1, which comprises using at least one of the following components for the system components: a transformer, a line, a switching device, protective equipment, a grid regulator.

7. The computer-implemented method according to claim 1, which comprises assigning component properties to recognized component types based on a predefined taxonomy and a predefined set of rules.

8. An arrangement for analyzing network information in an electrical energy supply grid, the arrangement comprising:
a communication device configured to receive serialized network information in a first application-specific data format, the serialized network information containing information about system components;
a deserialization device configured to deserialize the serialized network information;
a first assignment device configured to assign component types based on the information about system components;
a second assignment device configured to assign component properties based on the information about the system components; and
a topology output device configured to provide a network topology, in form of a graph containing types and properties of the system components, in a second application-specific data format.

9. The arrangement according to claim 8, further comprising a grid control device configured to use the network topology to control the electrical energy supply grid.

10. The arrangement according to claim 8, wherein said deserialization device is configured to use a rule-based method for a deserialization in which identification columns in data tables are recognized based on the serialized network information, and the system components are recognized as being connected to one another based on identifiers in the identification columns.

11. The arrangement according to claim 8, wherein said first assignment device is configured to use a rule-based method to recognize the component types.

12. The arrangement according to claim 8, wherein said first assignment device is configured to use machine learning to recognize the component types.

13. The arrangement according to claim 8, wherein the system components are one or more components selected from the group consisting of: a transformer, a line, a switching device, protective equipment, and a grid regulator.

14. The arrangement according to claim 8, wherein said second assignment device is configured to assign the component properties to the recognized component types based on a predefined taxonomy and a predefined set of rules.

15. A non-transitory computer program product comprising instructions that, when the program is executed by a computer, cause the computer to carry out the method according to claim 1.
